(19) United States
(12) Patent Application Publication
(10) Pub. No.: US 2011/0145854 A1
(43) Pub. Date: Jun. 16, 2011

(54) SYSTEMS AND METHODS FOR DIGITAL PROGRAM INSERTION WITHIN SCRAMBLED CONTENT

(75) Inventors: Kinney Chapman Bacon, Lawrenceville, GA (US); Altan John Stalker, Lawrenceville, GA (US)

(73) Assignee: CISCO TECHNOLOGY, INC., San Jose, CA (US)

(21) Appl. No.: 12/637,259

(22) Filed: Dec. 14, 2009

(51) Int. Cl. H04N 7/167; H04N 7/025; H04J 1/00; H04L 12/56

(52) U.S. Cl. 725/31; 725/32; 370/480; 370/390

(57) ABSTRACT

Systems and methods for digital program insertion. Entitlement control messages (ECMs) may be sent over an out-of-band communication channel to a client device such that the ECMs are received proximate in time to splice points where, e.g., advertising is inserted into a scrambled program or when the scrambled program is to resume at the end of the ad or program insertion. The ECMs may be communicated over the out-of-band channel having a timing such that the client device can process the ECMs, extract a control word and begin descrambling of the scrambled program to provide near seamless splices. In some implementations, out-of-band bandwidth is conserved as the ECMs are sent a splice time, rather than continuously.

### BACKGROUND

Digital Program Insertion (DPI) allows network or service providers and broadcast affiliates to insert advertising or short programs into remotely distributed regional programs before they are delivered to home viewers. Standards are in place to support splicing of MPEG-2 streams for digital ad insertion and establish a standardized method for communication between servers and splicers for the insertion of content.

“Program Insertion” and “Ad Insertion,” refer to DPI functionality. For example, the cable systems that ultimately distribute the programming may be permitted, under certain circumstances, to insert advertisements at specified points in the program. In North America, these points are termed “avails.” Where advertising revenue is not a factor, local content or promotions may be inserted into a national feed. Typically, this will be local news, but other programming may be inserted as well.

When the MPEG-2 streams are scrambled, the streams are not viewable without a control word, which is changed typically once every 4-12 seconds. As such, under current implementations, the MPEG-2 transport stream must be received to obtain the current control word. The control words are generated by a control word generator, typically using random numbers. The control word is typically scrambled and passed to a client device within an entitlement control message (ECM). However, it takes a finite and noticeable amount of time for the client device to receive the ECM, decrypt it, and then begin descrambling the program using the current control word. This is because the ECMs are transmitted within the MPEG-2 transport stream at a constant rate, typically 10 times a second, and it takes a finite period of time to decrypt the ECM. As such, this time period prevents a seamless transition to a scrambled program during DPI operations.

### SUMMARY

Systems and methods for digital program insertion. Entitlement control messages (ECMs) may be sent over an out-of-band communication channel to a client device such that the ECMs are received proximate in time to splice points where, e.g., advertising is inserted into a scrambled program or when the scrambled program is to resume at the end of the ad or program insertion. The ECMs may be communicated over the out-of-band channel having a timing such that the client device can process the ECMs, extract a control word and begin descrambling of the scrambled program to provide near seamless splices. In some implementations, out-of-band bandwidth is conserved as the ECMs are sent a splice time, rather than continuously.

In some implementations, a method is provided wherein a first program within a first transport stream communicated to a client device and a second program within a second transport stream is communicated to the client device. Second entitlement control messages may be communicated to the client device over an out-of-band communication channel. The second entitlement control messages are associated with the second program and are communicated proximate in time to first cueing control signals instructing the client to insert the second program into the first program at a first splice point.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 depicts an exemplary environment of a digital television content delivery system.

FIG. 2 depicts the headend of FIG. 1 in greater detail.

FIGS. 3-4 illustrate example flow diagrams that illustrate the operation of sending ECMs in an out-of-band message.

FIG. 5 is a timing diagram of the operations performed in the flow diagrams of FIGS. 3-4.

FIG. 6 shows an exemplary computing environment in which example embodiments and aspects may be implemented.

### DETAILED DESCRIPTION

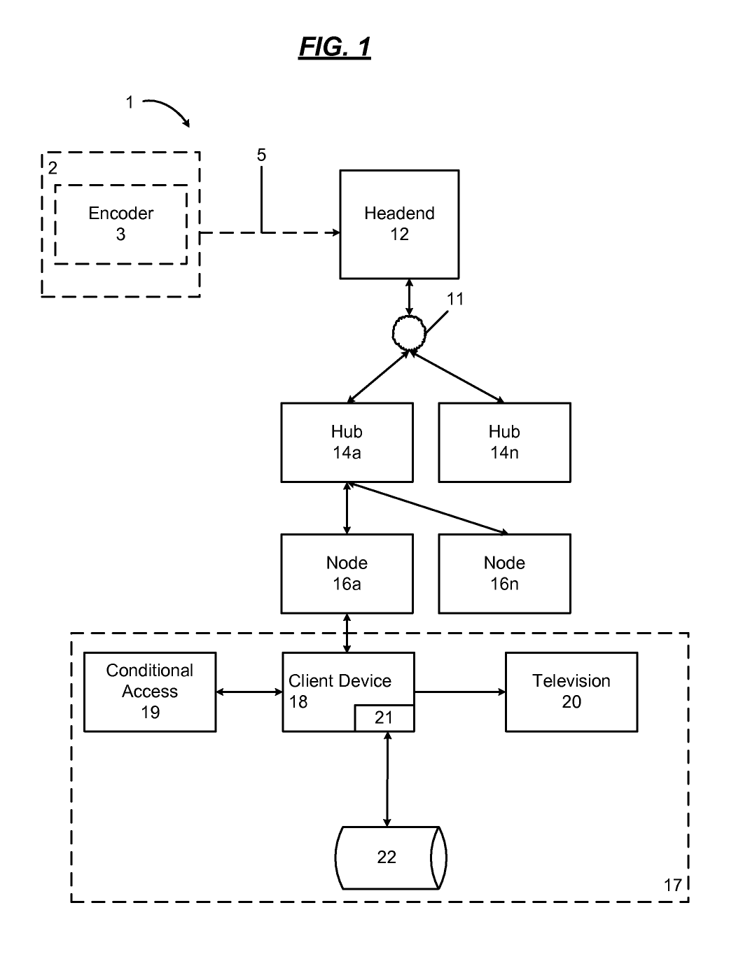

As will be described in detail herein with reference to several exemplary implementations, systems and methods for digital program insertion wherein entitlement control messages are sent over an out-of-band channel to a client device. The entitlement control messages may be sent at a splice time to reduce bandwidth utilization and to provide near seamless splicing. An overview of a digital television content delivery system 1 is shown in FIG. 1. An A/V encoder 3 in, e.g., a broadcast center 2 may receive an analog signal. The A/V encoder 3 may encode the analog audio/video content into a variety of formats including, but not limited to MPEG-2 and MPEG-4. The digital broadcast center may be connected to a headend 12 by a communication link 5 to provide digital programming content to the headend 12. The link 5 may take a wide variety of forms including telecommunications links, WAN, LAN, etc.

Signals are transmitted from the headend 12 to a client device 18 through a communication network 11, one or more hubs 14a-14n and nodes 16a-16n. The hubs 14a-14n receive programming and other information, which is typically in a protocol such as ATM or Ethernet, from the headend 12 via a transmission medium. The hubs 14a-14n transmit information and programming via the transmission medium to nodes 16a-16n, which then transmit the information to subscriber locations (e.g., location 17) via another transmission medium. Whether the hubs 14a-14n communicate directly to subscriber locations or to nodes 16a-16n is matter of implementation. The transmission medium between headends, hubs and nodes may be optical fibers that allow the distribution of high quality and high-speed signals, and the transmission medium between the hubs/nodes and the subscriber location may be either broadband coaxial cable, optical fiber, or other transmission media.

The hubs 14a-14n may function as a mini-headend for the introduction of programming and services to a distribution network. This arrangement may facilitate the introduction of different programming, data and services to different sub-distribution networks of the system 1. For example, the subscriber location 17, which is connected to node 16a, may have different services, data and programming available than the services, data and programming available to another subscriber location, which may be connected directly to the headend 12, hub 14a, etc. Services, data and programming for subscriber location 17 are routed through hubs 14a-14n and nodes 16a-16n; and hubs 14a-14n can introduce services, data and programming that are not available through the headend 12.

The client device 18 decodes the compressed MPEG-2 signal into a television signal for the television set 20. The client device may also be part of an integrated digital television. As used herein, the term “client device” includes a separate client device, such as a set-top box, a digital subscriber communication terminal, a television having a client device integrated therewith, etc. The client device 18 receives services from the headend 12 and may manage a local area network (LAN) at the subscriber's premises, as well as and provides services to client-receivers coupled to the LAN. The client device 18 is adapted to, among other things, selectively provide the services received from the headend 12 to the subscriber location 17.

A conditional access system 19 is connected to the client device 18, and has aspects located partly in the headend 12 and partly in the client device 18. The conditional access system 19 enables the end user to access digital television broadcasts from one or more broadcast suppliers. For example, a smartcard or dedicated hardware (e.g., conditional access device, such as a CableCARD), capable of deciphering messages relating to commercial offers, can be inserted into or included with the client device 18. Using the client device 18 and the conditional access device, the end user may purchase commercial offers, premium content, etc. in either a subscription mode or a pay-per-view mode.

The programs transmitted by the system may be scrambled and the conditions and encryption keys applied to a given transmission are determined by the conditional access system 19. An exemplary conditional access system is described in U.S. Pat. Nos. RE33,189 and 4,484,027, to Lee et al., which is incorporated by reference herein in its entirety.

The scrambled data and encrypted control word are then received by the client device 18 having access to an equivalent to the entitlement key inserted in the client device to decrypt the encrypted control word and thereafter descramble the transmitted data with the control word. For example, a paid-up subscriber will receive, for example, an Entitlement Management Message (EMM) in a broadcast with the entitlement key necessary to decrypt the encrypted control word so as to permit viewing of the transmission.

The headend 12 may communicate with client device 18 (and vice-versa) using, e.g., an Out of Band (OOB) communication channel along the transmission media between the headend 12, hubs 14a-14n and nodes 16a-16n. The OOB communication may be any data flow that is separate from the logical A/V data, such as a Quadrature phase-shift keying (QPSK) or DOCSIS System Gateway (DSG) signal, an Internet Protocol (IP) path, etc. In some implementations, communication between the headend 12 and client device 18 may be provided using other communication media, such as a Public Switched Telephone Network (PST) channel, a LAN or a WAN connection, or an Internet connection. OOB communications may be used for the conditional access system 19, providing program data and information, channel lineups, software code, providing and/or in a content management and protection system.

Using a mass storage device 22 attached to the client device, portions of the received transmission can be recorded and stored for later viewing. The mass storage device 22 can be, for example, a hard disc, solid-state memory unit, or other suitable medium, and may be incorporated within the client device 18, or may be provided separately. The mass storage device 22 may even be static or dynamic memory within or external to the client device 18. Suitable interfacing software 21 and optionally hardware may be provided within the client device. The contents of recordings stored on the mass storage device 22 may be protected using the conditional access system 19 or other mechanism.

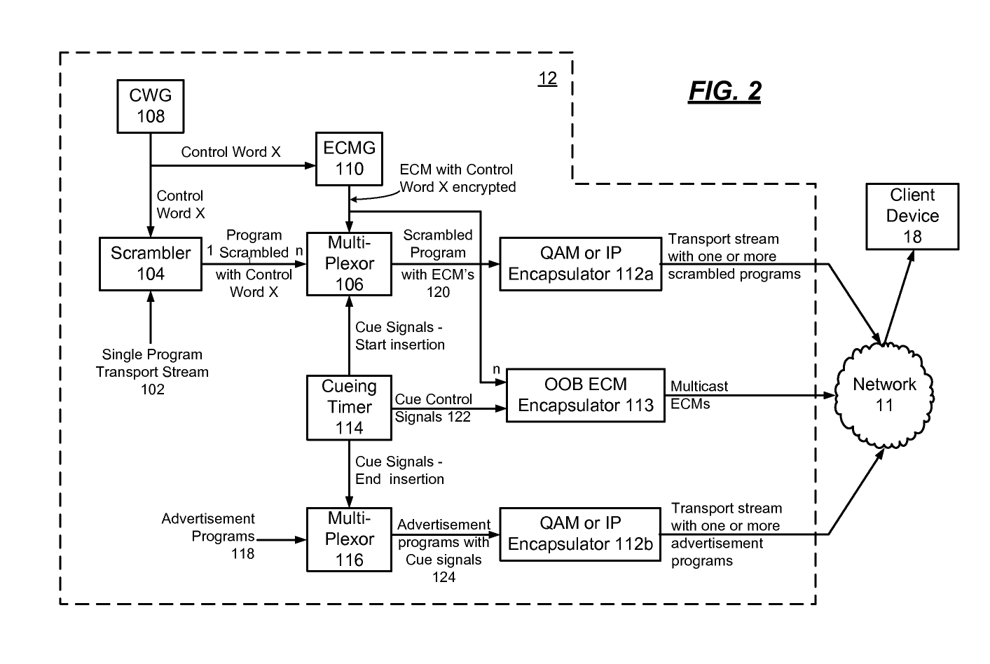

The control word may be used to build an Entitlement Control Message (ECM) that is sent in relation with a scrambled program. The ECM may be an encrypted version of the control word that allows for the descrambling of the program at the client device 18. In some implementations, the ECM is generated in an ECM Generator (see, reference 110, FIG. 2).

The client device 18 receives the broadcast signal and extracts the A/V data stream (e.g., MPEG-2, MPEG-4, etc.). If a program is scrambled, the client device 18 extracts the corresponding ECM from the, e.g., MPEG-2 stream and passes the ECM to the conditional access system 19. If the end user has rights to the program, the ECM is decrypted and the control word extracted. The client device 18 can then descramble the program using this control word. The MPEG-2 stream is decoded and translated into a video signal for onward transmission to television set 20. If the program is not scrambled, no ECM will have been transmitted with the MPEG-2 stream and the client device 18 decodes the data and transforms the signal into a video signal for transmission to television set 20.

FIG. 2 illustrates the headend 12 in greater detail. In some implementations described below, ECMs are sent in an out-of-band communication channel as part of systems and methods to implement digital program insertion. The ECMs may be communicated at splice time, which results in a reduction in the out-of-band bandwidth requirements and provides for near seamless splices between a scrambled program transport stream and an advertisement transport stream, and vice versa.

As shown in FIG. 2, a single program transport stream 102, which may include audio and video (A/V) data for a program, such as CNN, is input to a scrambler 104. A control word generator (CWG) 108 provides a control word, e.g., a random number that is used as a key for encrypting the transport stream 102 and/or other content. The CWG passes the control word to the scrambler 104 and to an entitlement control message generator (ECMG) 110 that generates an entitlement control message (ECM). The ECM may contain a scrambled (e.g., encrypted) version of the control word generated by the CWG. The ECM may be passed to a multiplexor 106.

As noted above, in systems that implement Digital Program Insertion (DPI), client devices 18 may switch from a program to an advertisement when queued to do so, and then switch back to the program when the advertisement has completed. A cueing timer 114 may be used to generate the timing signals, which are inserted into the multiplexor 106 and will instruct the client device 18 when to switch to an advertisement program or resume an original program. Start and end cue commands may be generated by the cueing timer 114 to instruct the client device 18 to start and to stop the digital advertising insertion.

The multiplexor 106 may receive a plurality of transport streams and data, ECMs and start cue commands and combine them into a transport stream 120. The transport stream 120 may be an MPEG-2 transport stream consists of multiple programs with the associated data to discover and decrypt the programs. For example, the transport stream may include combinations of the scrambled programs, ECMs and start cue commands. The transport stream 120 may be encapsulated for transport over the network 11 to the client device 18 by a Quadrature amplitude modulation (QAM) modulator or IP encapsulator 112a. The output may be formatted using IP, QAM, or other protocol/modulation techniques for communication in accordance with network 11 topology.

A multiplexor 116 may receive advertisement programs 118 that are usually, but not always, on a different transport stream than the A/V data for a particular program. The advertisement programs 118 are multiplexed together with end cue signals generated by the cueing timer 114 and output as a transport stream 124. The transport stream 124 may be encapsulated for transport over the network 11 to the client device 18 by a QAM or IP encapsulator 112b. In some implementations, the advertising transport stream carrying the advertisement programs and the program transport stream may be one and the same.

In accordance with some implementations, cue control signals 122 from the cueing timer 114 and ECMs from the ECMG 110 are encapsulated by an OOB ECM encapsulator 113 and communicated over the network 11 to the client device 18. The ECMs may be multicast and carry common access rules for the programs in the multiplexed transport stream 120. Providing the ECMs in the OOB communication channel enables the client device 18 to keep its internal memory active with the current control word for scrambled programs, thereby removing the time it takes to receive and descramble the ECM. This also reduces or eliminates the visible delay associated with a channel change where time is needed to fill an MPEG buffer with new data associated with the new channel as a result of the channel change operation.

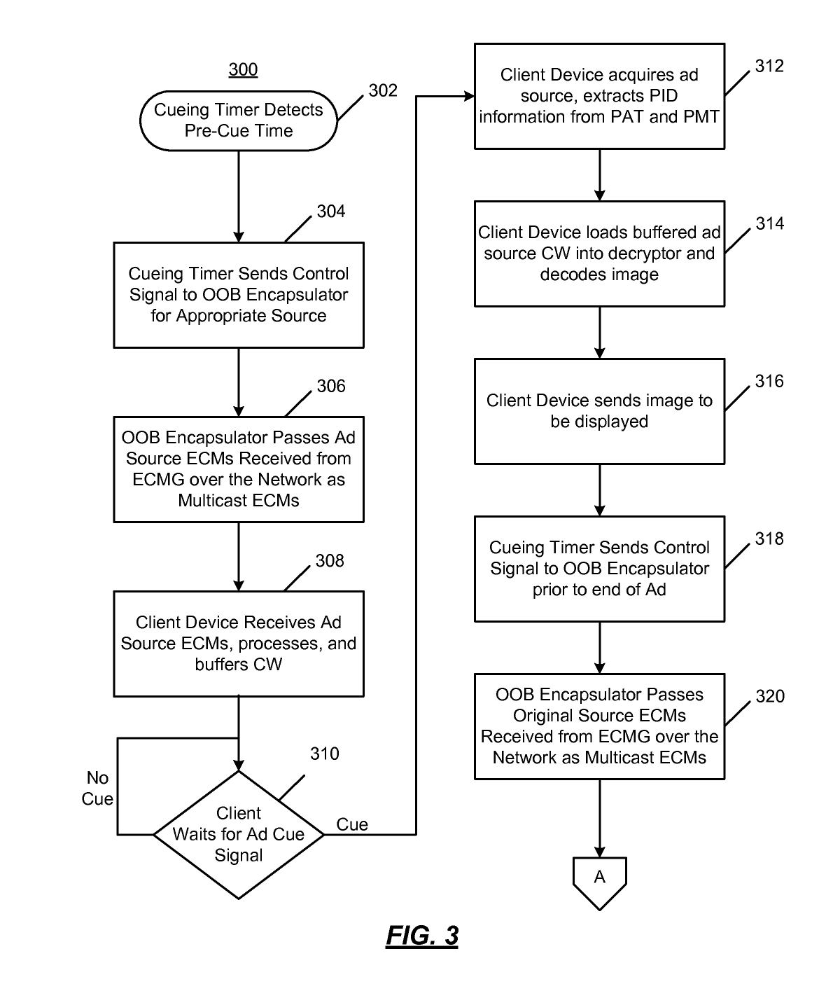

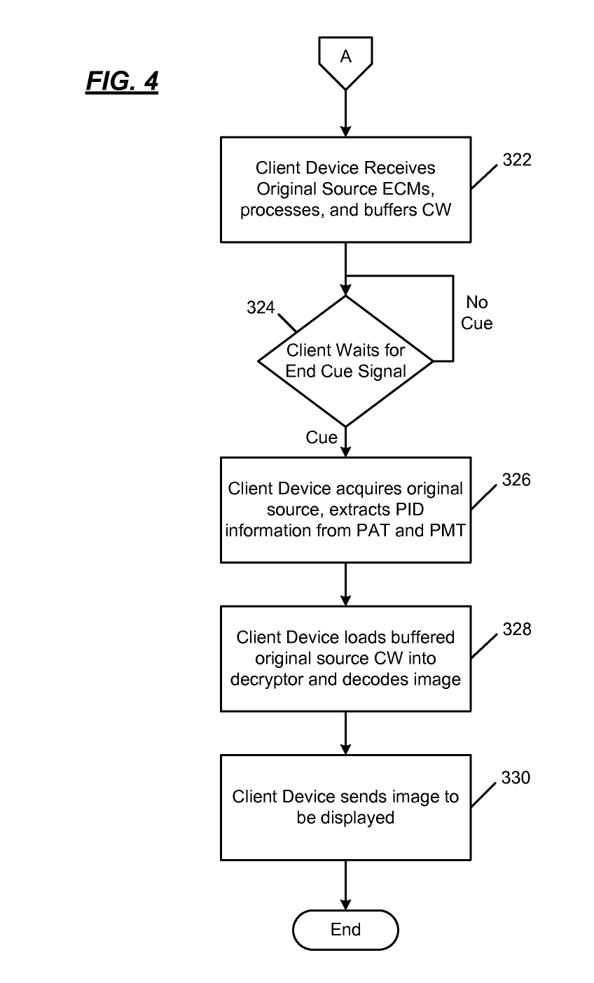

FIGS. 3 and 4 illustrate example flow diagrams 300 that illustrate the operation of sending ECMs in an out-of-band message. At 302, the cueing timer 114 detects pre-cue time. The cueing timer 114 may detect a time at which a program (e.g., advertisement) is to be inserted into another program. At 304, the cueing timer 114 sends a control signal to the OOB encapsulator 113 for the appropriate source. The source may be, for example, advertising programs 118.

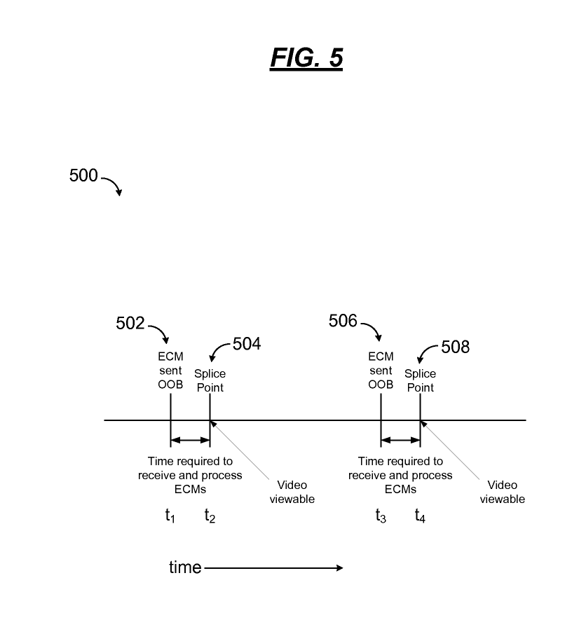

At 306, the OOB Encapsulator 113 passes the advertisement source ECMs received from the ECMG 110 over the network as multicast ECMS. At 308, the client device 18 receives the advertisement source ECMs through the OOB communication channel. The client device 18 may process and buffer the control word contained in the advertisement source ECMs. With reference to FIG. 5, the ECMs are sent at a time t₁ indicated by reference numeral 502.

At 310, the client waits for an advertisement cue signal. The cue signals may be included in the transport stream received by the client device 18. If cue signal is not received, the client device 18 continues to wait. If a cue signal is received, then the process continues at 312, where the client device 18 acquires the advertisement source, extracts Packet ID (PID) information from the Program Association Table (PAT) and the Program Map Table (PMT). The PAT lists all programs available in the transport stream. Each of the programs listed in PAT has an associated value of PID for its PMT. The PMT contains information about programs. The advertising source may be in, e.g., transport stream 124.

At 314, the client device 18 loads the buffered advertisement source control word into a decryptor, decrypts the advertisement program, and decodes the advertisement source (e.g., transport stream). At 316, the client device 18 sends the decrypted and decoded audio/video to be displayed. The advertisement audio/video may be output to the television 20. With reference to FIG. 5, steps 312-316 may take place during the time period between t₁ and t₂ (indicated by reference numerals 502 and 504).

At 318, the cueing timer 114 sends a control signal to the OOB Encapsulator 113 prior to end of advertisement. This may occur at time t₃, indicated by reference numeral 506 in FIG. 5. At 320, the OOB Encapsulator 113 passes the original source ECMs received from ECMG 110 over the network as Multicast ECMs. The original source ECMs may be associated with the program contained in the transport stream 120. The process then continues to 322, in FIG. 4, where the client device 18 receives the original source ECMs through the OOB communication channel. The client device 18 may the process and buffer the control word contained in the original source ECMs.

At 324, the client device 18 waits for an end cue signal. If an end cue signal is not received, the client device 18 continues to wait. If an end cue signal is received, then the process continues at 326, where the client device 18 acquires the original source, and extracts PID information from PAT and PMT. At 338, the client device 18 loads the buffered original source control word into a decryptor and decodes the original source (e.g., transport stream). At 330, the client device 18 sends the decrypted and decoded audio/video to be displayed. The advertisement audio/video may be output to the television 20. With reference to FIG. 5, steps 326-330 may take place during the time period between t₃ and t₄ (indicated by reference numerals 506 and 508).

As described in the implementations above, timing signals and ECMs are communicated to a client device using an OOB communication channel. The ECMs are communicated at a point in time where a splice point exists in the programming. As such, near seamless splicing may be accomplished while minimizing the use of OOB bandwidth.

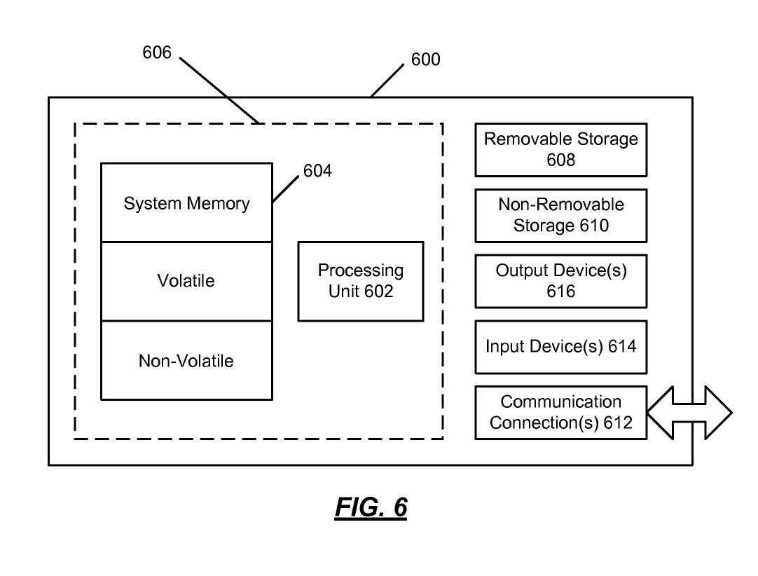

FIG. 6 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers (PCs), server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communication network or other data transmission medium. In a distributed computing environment, program modules and other data may be located in both local and remote computer storage media including memory storage devices.

With reference to FIG. 6, an exemplary system for implementing aspects described herein includes a computing device, such as computing device 600. The computing device 600 may be configured to perform the descrambling, decryption, conditional access and decoding functionalities described above. In its most basic configuration, computing device 600 typically includes at least one processing unit 602 and system memory 604. Depending on the exact configuration and type of computing device, system memory 604 may be volatile (such as random access memory (RAM)), non-volatile (such as read-only memory (ROM), flash memory, etc.), or some combination of the two. This most basic configuration is illustrated in FIG. 6 by dashed line 606.

Computing device 600 may have additional features and/or functionality. For example, computing device 600 may include additional storage (removable and/or non-removable) including, but not limited to, magnetic or optical disks or tape. Such additional storage is illustrated in FIG. 6 by removable storage 608 and non-removable storage 610.

Computing device 600 typically includes a variety of computer-readable media. Computer-readable media can be any available media that can be accessed by computing device 600 and includes both volatile and non-volatile media, removable and non-removable media. By way of example, and not limitation, computer-readable media may comprise computer storage media and communication media.

Computer storage media include volatile and non-volatile, removable and non-removable media implemented in any method or technology for storage of information such as computer-readable instructions, data structures, program modules or other data. System memory 604, removable storage 608, and non-removable storage 610 are all examples of computer storage media. Computer storage media includes, but are not limited to, RAM, ROM, Electrically Erasable Programmable Read-Only Memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of computing device 600.

Computing device 600 may also contain communication connection(s) 612 that allow the computing device 600 to communicate with other devices. Communication connection(s) 612 is an example of communication media, and may include in-bound and out-of-band communication paths. Communication media typically embody computer-readable instructions, data structures, program modules, or other data in a modulated data signal such as a carrier wave or other transport mechanism, and include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared, and other wireless media. The term computer-readable media as used herein includes both storage media and communication media.

Computing device 600 may also have input device(s) 614 such as keyboard, mouse, pen, voice input device, touch input device, etc. Output device(s) 616 such as a display, speakers, printer, etc. may also be included. All these devices are well known in the art and need not be discussed at length here.

Computing device 600 may be one of a plurality of computing devices 600 inter-connected by a network. As may be appreciated, the network may be any appropriate network, each computing device 600 may be connected thereto by way of communication connection(s) 612 in any appropriate manner, and each computing device 600 may communicate with one or more of the other computing devices 600 in the network in any appropriate manner. For example, the network may be a wired or wireless network within an organization or home or the like, and may include a direct or indirect coupling to an external network such as the Internet or the like.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although exemplary embodiments may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method, comprising:
providing a first program within a first transport stream communicated to a client device;
providing a second program within a second transport stream communicated to the client device; and
communicating second entitlement control messages to the client device over an out-of-band communication channel, the second entitlement control messages associated with the second program and being communicated proximate in time to cueing signals instructing the client to insert the second program into the first program at a first splice point.

2. The method of claim 1, further comprising communicating first entitlement control messages over the out-of-band communication channel, the first entitlement control messages being associated with the first program and communicated proximate in time to the second splice point in the second program wherein the first program is to be resumed.

3. The method of claim 2, further comprising multicasting the first and second entitlement control messages.

4. The method of claim 2, further comprising:
buffering a first control word associated with the first entitlement control messages; and
waiting for an end insertion cueing signal to resume the first program at the second splice point.

5. The method of claim 4, further comprising:
receiving the end insertion cueing signal;
extracting packet identifier information from a program association table and a program mapping table;
loading the first control word into a decryptor;
decoding the first program; and
providing the first program at the second splice point.

6. The method of claim 2, further comprising:
inserting the start insertion cueing signal in the first transport stream; and
inserting the end insertion cueing signal in the second transport stream.

7. The method of claim 2, wherein communication to the client device is one of modulated signal or Internet Protocol.

8. The method of claim 1, further comprising:
receiving the start insertion cueing signal;
decoding the second program; and
providing the second program at the first splice point.

9. The method of claim 1, wherein the first transport stream and the second transport stream are a single transport stream.

10. A system for digital program insertion, comprising
a first multiplexor that multiplexes a first program with first entitlement control messages and start insertion cue signals onto a first transport stream;
a second multiplexor that multiplexes a second program and end insertion cue signals onto a second transport stream; and
an out-of-band entitlement control message encapsulator that encapsulates first entitlement control messages that are communicated to a client device over an out-of-band communication channel, the first entitlement control being associated with the first program,
wherein the first entitlement control messages are received by the client device over the out-of-band communication channel proximate in time to an end insertion cue signal to instruct the client device to resume the first program at an end of an insertion period.

11. The system of claim 10, wherein the second transport stream is encrypted, wherein the second multiplexor multiplexes the second program, second entitlement control messages onto the second transport stream.

12. The system of claim 11, wherein second entitlement control messages associated with the second program are received by the client device over the out-of-band communication channel proximate in time to a start insertion cue signal, and wherein the second program is inserted into the first program at the start of the insertion period.

13. The system of claim 12, wherein the first and second entitlement control messages are multicasted to the client device.

14. The system of claim 10, wherein the client device buffers a first control word associated with the first entitlement control messages and awaits the end insertion cue signal.

15. The system of claim 14, wherein the client device receives the end insertion cue signal and extracts a packet identifier information from a program association table and a program mapping table, and wherein the client devices decrypts and decodes the first program.

16. The system of claim 10, wherein communication to the client device is one of a modulated signal or Internet Protocol.

17. The system of claim 10, wherein the first transport stream and the second transport stream are a single transport stream.

18. A computer readable medium containing computer executable instructions that when executed by a computing device perform the method, comprising:
providing a first program within a first transport stream communicated to a client device;
providing a second program within a second transport stream communicated to a client device;
communicating second entitlement control messages to the client device over an out-of-band communication channel, the second entitlement control messages being associated with the second program and communicated proximate in time to cueing control signals instructing the client to insert the second program into the first program at a first splice point; and
communicating first entitlement control messages over the out-of-band communication channel associated with the first program, the first entitlement control messages being associated with the first program and communicated proximate in time to cueing control signals instructing the client to resume the first program at a second splice point in the second program.

19. The computer readable medium of claim 18, further comprising instructions for providing the first transport stream and the second transport stream as a single transport stream.

20. The computer readable medium of claim 18, further comprising instructions for multicasting the first entitlement control messages.
